(19) United States
(12) Patent Application Publication
(10) Pub. No.: US 2026/0154222 A1
(43) Pub. Date: Jun. 4, 2026

(54) PRINTING APPARATUS AND CONTROL METHOD OF PRINTING APPARATUS

(71) Applicant: CANON KABUSHIKI KAISHA, Tokyo (JP)

(72) Inventors: Hiroyuki Hosogoshi, Kanagawa (JP); Kazuhisa Fujino, Kanagawa (JP); Saki Narushima, Kanagawa (JP); Masao Maeda, Kanagawa (JP)

(21) Appl. No.: 19/405,865

(22) Filed: Dec. 2, 2025

(30) Foreign Application Priority Data
Dec. 4, 2024 (JP) 2024-211183

(51) Int. Cl. G06F 13/38; G06F 13/40; G06F 13/42

(52) U.S. Cl. CPC G06F 13/382; G06F 13/4081; G06F 13/4282; G06F 2213/3812

(57) ABSTRACT

Provided is a technique of making it possible to connect a single type of a USB device to multiple USB connection ports and using different functions depending on the multiple USB connection ports. To this end, a USB port 350 and a USB port 360 are functioned by connecting to the USB device, and the functions of the USB port 350 and the USB port 360 are set to be different from each other in a case of connecting to the USB device. In addition, in a case where the function of either one of the USB port 350 and the USB port 360 does not correspond to the connected USB device, a warning screen is displayed on an operation panel 303.

### BACKGROUND

### Field of the Technology

The present disclosure relates to a printing apparatus utilized by connecting to a USB device and a control method of the printing apparatus.

### Description of the Related Art

Some of USB devices used by connecting with a printing apparatus include a storage region that can store data therein, and a printing apparatus having multiple functions to utilize the storage region of the USB device has been commonly used.

Japanese Patent Laid-Open No. 2018-122597 describes a restriction on the use of a particular USB device (a USB wireless LAN adaptor) with a particular one of multiple connection ports (sockets) that can be connected to the USB device.

However, according to the method described in Japanese Patent Laid-Open No. 2018-122597, in a case where a single type of a USB device is connected to the multiple connection ports and used with different functions depending on the connection ports, it is impossible to control the connection properly.

### SUMMARY

Therefore, a printing apparatus of the present disclosure includes: a first USB port; a second USB port different from the first USB port; a notification unit configured to perform notification in a predetermined state; and a control unit configured to perform control related to connection of a USB device including a data storage region to the first USB port and the second USB port and control of the notification unit, in which the first USB port and the second USB port can be functioned by connecting to the USB device, functions of the first USB port and the second USB port in a case of connecting to the USB device can be set to be different from each other, and in a case where the function of either one of the first USB port and the second USB port does not correspond to the connected USB device, the control unit performs notification by the notification unit.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration of a system including a printing apparatus;

FIG. 2 is a block diagram illustrating a configuration of a control system in the printing apparatus;

FIG. 3 is a perspective view illustrating exterior and a partially enlarged view of the printing apparatus;

FIG. 4 is a table illustrating a function in a case of utilizing a USB memory by connecting to the printing apparatus;

FIG. 5 is a diagram illustrating a data structure saved in a non-volatile memory;

FIG. 6 is a diagram showing the relationship between FIGS. 6A and 6B

FIG. 6A is a diagram illustrating a menu configuration and a setting item of an operation panel;

FIG. 6B is a diagram illustrating a menu configuration and a setting item of an operation panel;

FIG. 7 is a flowchart illustrating processing by a CPU;

FIG. 8 is a flowchart illustrating the relationship between FIGS. 8A and 8B.

FIG. 8A is a flowchart illustrating processing in a case where a device is connected to a USB port;

FIG. 8B is a flowchart illustrating processing in a case where a device is connected to a USB port;

FIG. 9A is a diagram illustrating an example of a screen displayed on the operation panel;

FIG. 9B is a diagram illustrating an example of a screen displayed on the operation panel;

FIG. 9C is a diagram illustrating an example of a screen displayed on the operation panel;

FIG. 9D is a diagram illustrating an example of a screen displayed on the operation panel;

FIG. 9E is a diagram illustrating an example of a screen displayed on the operation panel;

FIG. 9F is a diagram illustrating an example of a screen displayed on the operation panel;

FIG. 9G is a diagram illustrating an example of a screen displayed on the operation panel;

FIG. 9H is a diagram illustrating an example of a screen displayed on the operation panel;

FIG. 9I is a diagram illustrating an example of a screen displayed on the operation panel;

FIG. 9J is a diagram illustrating an example of a screen displayed on the operation panel;

FIG. 10 is a flowchart illustrating processing in a case where the device is connected to the USB port;

FIG. 11A is a diagram illustrating each screen displayed by the processing in a case where the device is connected to the USB port;

FIG. 11B is a diagram illustrating each screen displayed by the processing in a case where the device is connected to the USB port;

FIG. 11C is a diagram illustrating each screen displayed by the processing in a case where the device is connected to the USB port; and

FIG. 12 is a flowchart illustrating the relationship between FIGS. 12A and 12B.

FIG. 12A is a flowchart illustrating processing in a case where the device is connected to the USB port.

FIG. 12B is a flowchart illustrating processing in a case where the device is connected to the USB port.

### DESCRIPTION OF THE EMBODIMENTS

### First Embodiment

In the following, a first embodiment of the present disclosure is described with reference to the drawings.

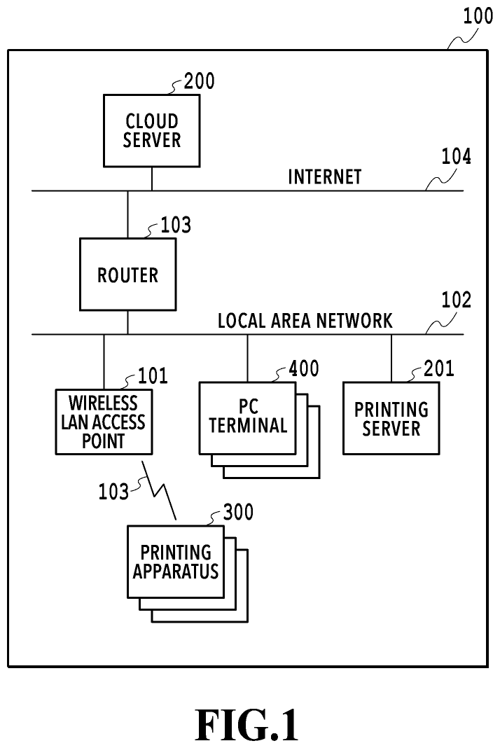

FIG. 1 is a diagram illustrating a configuration of a system 100 including a printing apparatus 300 in the present embodiment. The system 100 is connected with a PC terminal 400, a wireless LAN access point 101, and a printing server 201 via a local area network 102. The printing apparatus 300 is connected to the local area network 102 by wireless connection with the wireless LAN access point 101. The printing apparatus 300 and the wireless LAN access point 101 are connected to each other by wireless LAN infrastructure mode connection. Additionally, the local area network 102 is connected to the Internet 104 by way of a router 103.

The printing apparatus 300 and other devices communicate with a cloud server 200 on the Internet 104 by way of the router 103. A terminal device such as the PC terminal 400 causes the printing apparatus 300 to execute printing by way of the printing server 201 and confirms a state of the printing apparatus 300. Note that, the configuration indicates merely an example of the present disclosure, and the same effect of the present disclosure is obtained with a different configuration. For example, although the wireless LAN access point 101 and the router 103 are formed as different devices in FIG. 1, a router device having an access point function may be applied.

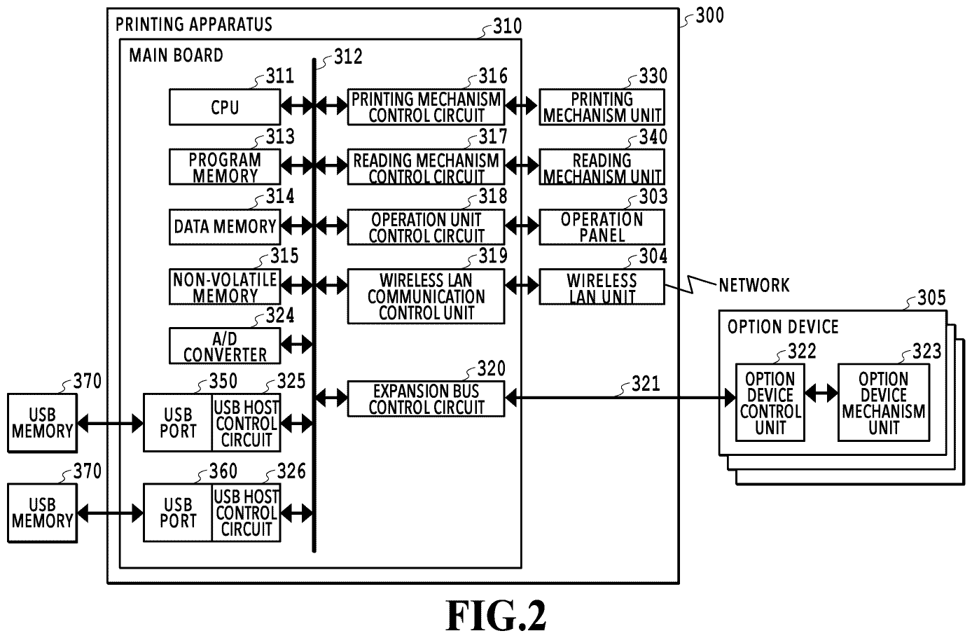

FIG. 2 is a block diagram illustrating a configuration of a control system in the printing apparatus 300. The printing apparatus 300 includes various units such as a main board 310 that controls overall the apparatus, an operation panel 303 provided to an outer surface of the apparatus, and a wireless LAN unit 304. A CPU 311 in the form of a microprocessor arranged on the main board 310 operates according to a control program stored in a program memory 313 in the form of a ROM and data in a data memory 314 in the form of a RAM, which are connected to the CPU 311 via an internal bus 312. In addition, the printing apparatus 300 includes a non-volatile memory 315 that can hold contents without power supply and an A/D converter 324.

The CPU 311 writes various setting values, data, and the like into the non-volatile memory 315. Accordingly, in a case where the power is turned off temporarily, and then the power is supplied again to operate, the CPU 311 can continue the operation based on the same setting value and data. The CPU 311 controls a reading mechanism 340 via a reading mechanism control circuit 317 to read a document and stores the document in the data memory 314 as image data information. Additionally, the CPU 311 controls a printing mechanism 330 via a printing mechanism control circuit 316 to print the image data in the data memory 314 on a printing medium. The CPU 311 controls the wireless LAN unit 304 via a wireless LAN communication control unit 319 to establish wireless LAN communication with another device. The CPU 311 can display a state of the printing apparatus 300 and a function selection menu on the operation panel 303 by controlling an operation unit control circuit 318 and also accepts an operation from a user through the operation panel 303.

The CPU 311 controls an expansion bus control circuit 320 to control an option device 305 communicably connected via an expansion bus 321. The expansion bus control circuit 320 is electrically and communicably connected to an option device control unit 322 of the option device 305 mounted on the printing apparatus 300. The CPU 311 of the printing apparatus 300 obtains a state of the option device 305 and operates an option device mechanism unit 323 by communicating with a particular option device control unit 322 by way of the expansion bus 321.

Note that, although it is possible to mount multiple option devices 305 on the printing apparatus 300 concurrently, the CPU 311 can perform control by designating and communicating with the particular option device 305. A USB HOST control circuit 325 of the printing apparatus 300 controls connection with a USB memory 370 connected to the printing apparatus 300 via a USB port 350. Additionally, a USB HOST control circuit 326 controls connection with the USB memory 370 connected to the printing apparatus 300 via a USB port 360.

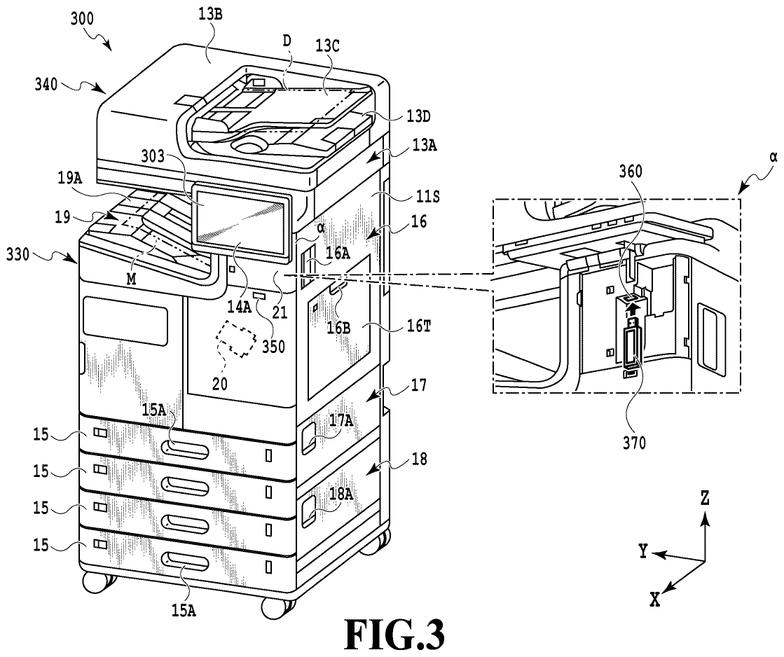

FIG. 3 is a perspective view illustrating exterior and a partially enlarged view of the printing apparatus 300. In FIG. 3, a Z direction is a vertical direction, and an X direction is a width direction of a medium M, which is a direction orthogonal to the Z direction. A Y direction is a direction orthogonal to the X direction. The printing apparatus 300 includes a printing mechanism unit 330 in a rectangular shape and a reading mechanism unit 340 arranged on the top of the printing mechanism unit 330. The printing mechanism unit 330 includes a conveyance path to convey the medium M such as a sheet. The reading mechanism unit 340 includes a reading unit 13A and an automatic document feeding unit 13B. The automatic document feeding unit 13B feeds a document D placed on a document tray 13C to the reading unit 13A and discharges the document D after being read by the reading unit 13A to a discharge tray 13D. Additionally, the reading unit 13A has not only the feeding type reading function to read the document D during the conveyance but also a flatbed type reading function to read the document D set on a platen that is exposed by opening the automatic document feeding unit 13B.

The printing apparatus 300 may include the operation panel 303. The operation panel 303 may include a display unit 14A formed of a touch panel, for example. That is, the user may be able to provide an instruction to the printing apparatus 300 by touch-operating the display unit 14A. The printing apparatus 300 includes a cassette 15 that can store multiple media M, and the cassette 15 may include a single tray or multiple trays (in FIG. 3, four trays). The cassette 15 is inserted and mounted in a lower portion of the printing mechanism unit 330 in a state detachable by sliding in an X axis direction using a handle 15A.

The printing mechanism unit 330 includes multiple cover doors 16, 17, and 18 on a side surface 11S. The multiple cover doors 16, 17, and 18 include handles 16A to 18A that allow the user to perform opening and closing operations. The first cover door 16 includes a feeding tray 16T on which the medium M can be placed. The feeding tray 16T includes a handle 16B that allows the user to perform opening and closing operations. The printing apparatus 300 includes a printing unit 20 that performs printing on the medium M. The printing unit 20 performs printing on the medium M fed from the cassette 15 and the medium M fed from the feeding tray 16T. The printing apparatus 300 includes a discharge unit 19 to which the medium M after printing is discharged. The discharge unit 19 includes a discharge tray 19A on which the medium M discharged from the printing mechanism unit 330 is stacked. The printing apparatus 300 may include a not-illustrated removable optional component. For example, a shift sorter having a sorting function of the medium M may be included in the discharge unit 19 to which the medium M after printing is discharged.

The printing apparatus 300 includes the USB port 350. The USB port 350 is provided on an outer side of a main body exterior cover of the printing apparatus 300 and is provided so as to be able to connect the USB memory 370 from the outside. Additionally, the printing apparatus 300 includes the USB port 360. The USB port 360 is provided inside of a lid 21 that is a part of the apparatus main body exterior cover of the printing apparatus 300, and the USB memory 370 can be connected thereto. The enlarged view illustrates an enlarged α portion, and in the enlarged view, the lid 21 is omitted so as to be able to confirm the USB port 360 easily. The lid (port cover) 21, which is a part of the main body exterior cover, includes a lock mechanism to physically lock the lid 21 to prevent the user from accessing the USB memory and prevent the user from accidentally inserting or removing the USB memory 370. Additionally, it is possible to electrically detect an open/closed state of the lock mechanism of the lid 21. Moreover, the printing apparatus 300 is formed to be able to control the access to the USB memory 370 connected to the USB port 360 based on authentication of an apparatus manager. Note that, the lock mechanism is not limited to the lid including the lock mechanism, and the lid may be locked by any mechanism as long as it is possible to prevent the user from accidentally inserting or removing the USB memory.

The USB port 350 and the USB port 360 can be used depending on the purpose. Additionally, although the USB port 350 and the USB port 360 are installed on the outer side and the inner side of the main body exterior cover of the printing apparatus 300, respectively, and can be used as described above, on the other hand, it is also possible to provide the USB port 350 and the USB port 360 on a main body front portion and a main body back portion printing apparatus 300, respectively, to be used. Moreover, the USB port 350 may be provided near the operation panel 303. In addition, as long as it is a position that prevents the accidental insertion and removement of the USB memory 370, the USB port 360 may not be necessarily arranged on the inner side of the main body exterior cover or the main body back portion. Note that, although an example in which the printing apparatus 300 includes the two ports in total, which are the USB port 350 and the USB port 360, is described in the present embodiment, an example of including three or more ports may be applicable.

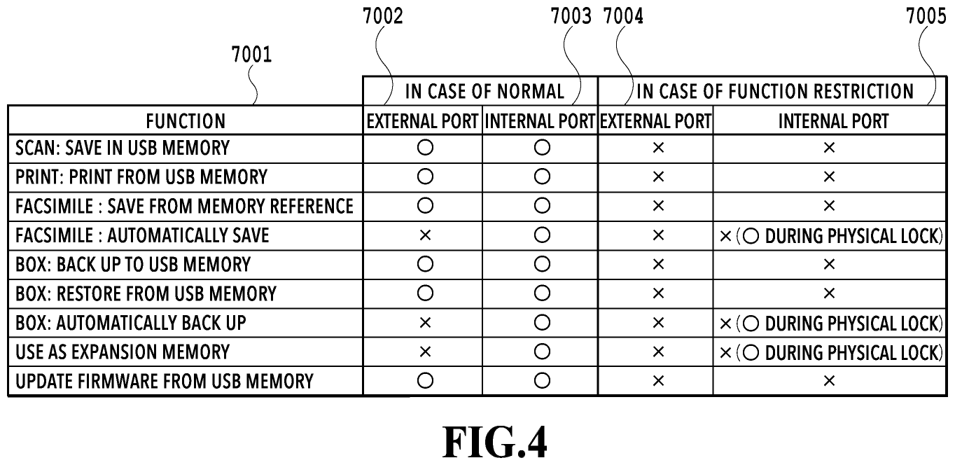

FIG. 4 is a table illustrating a function in a case of utilizing the USB memory 370 by connecting to the printing apparatus 300. Information illustrated in FIG. 4 is saved in the program memory 313, the non-volatile memory 315, or the like and is referred to during processing in a case of executing the function described later. Note that, “∘” illustrated in FIG. 4 means that a corresponding function is available, and “x” means that the corresponding function is unavailable. In the present embodiment, the printing apparatus 300 includes the USB port 350 and the USB port 360, and both the USB port 350 and USB port 360 can be used by connecting to the USB memory 370. Additionally, the USB port 350 and the USB port 360 may have different functions according to setting. Moreover, it is possible to set different utilization functions for the USB memory 370 by switching the functions between a case of “normal” (a state with no function restriction) and a case of “function restriction” according to security setting by the apparatus manager. In “function restriction,” it is possible to restrict the utilization function for the USB memory 370. In the following, the function for the USB memory 370 in a case of “normal” and in a case of “function restriction” is described.

Function 7001 indicates a list of the functions of the printing apparatus 300 that can be executed by connecting to the USB memory 370. A USB memory saving function in a scanning function is a function to read the image by a scanner of the printing apparatus 300 to print the image and to save the read scanned data in the USB memory 370 as an image file. A printing function from the USB memory in a printing function is a function to read out printing data such as an image file and a text document file saved in the USB memory 370 and to print (output) the printing data. A saving function from memory reference in a facsimile function is a function to select received facsimile reception data accumulated in a built-in memory and to save the data in the USB memory 370. An automatic saving function (an automatically executed function) in the facsimile function is a function to automatically save a facsimile image received during facsimile reception in the USB memory 370 by validating the function in advance.

A backup function to the USB memory in a BOX function is a function to back up data saved in a saving BOX provided to the built-in memory of the printing apparatus 300 into the USB memory 370. A restoring function from the USB memory in the BOX function is a function to restore the data saved in the USB memory 370 to the saving BOX provided to the built-in memory of the printing apparatus 300. An automatic backup function (an automatically executed function) in the BOX function is a function to automatically back up the data into the USB memory 370 by validating the function in advance, in a case where new data is saved in the BOX or in a case where the data saved in the BOX is changed.

A function of using as an expansion memory is a function to allow the USB memory 370 to be automatically utilized as the expansion memory based on a usage status of the built-in memory by validating the function in advance, in a case where a region for a spooling function and the like saved in the built-in memory is insufficient, for example. A firmware update function from the USB memory is a function to read update firmware saved in the USB memory 370 and to update the firmware of the printing apparatus 300.

External port 7002 indicates whether the USB memory 370 connected to the USB port 350 on the apparatus outer side of the printing apparatus 300 is available in a case where the function is not set to “function restriction” (in a case where the function is set to “normal”) for each function indicated in the function 7001. Internal port 7003 indicates whether the USB memory 370 connected to the USB port 360 on the apparatus inner side of the printing apparatus 300 is available in a case where the function is not set to “function restriction” (in a case where the function is set to “normal”) for each function indicated in the function 7001.

External port 7004 indicates whether the USB memory 370 connected to the USB port 350 provided on the apparatus outer side of the printing apparatus 300 is available in a case where the function restriction setting is performed (in a case of function restriction) for each function indicated in the function 7001. Internal port 7005 indicates whether the USB memory 370 connected to the USB port 360 provided on the apparatus inner side of the printing apparatus 300 is available in a case where the function restriction setting is performed (in a case of function restriction) for each function indicated in the function 7001.

A function with a note “∘ during physical lock” in the table indicates that the availability is changed depending on whether the USB memory 370 connected to the USB port on the apparatus inner side is in a physically locked state that prevents a person other than the manager from removing the USB memory 370 easily. In the physically locked state, the USB memory 370 is available, and in a state not physically locked, the USB memory 370 is unavailable.

Note that, although an example in which a case of performing and not performing the function restriction is switched based on FIG. 4 is described in the present embodiment, “∘” and “x” of each item in FIG. 4 may be set according to a request of the apparatus manager.

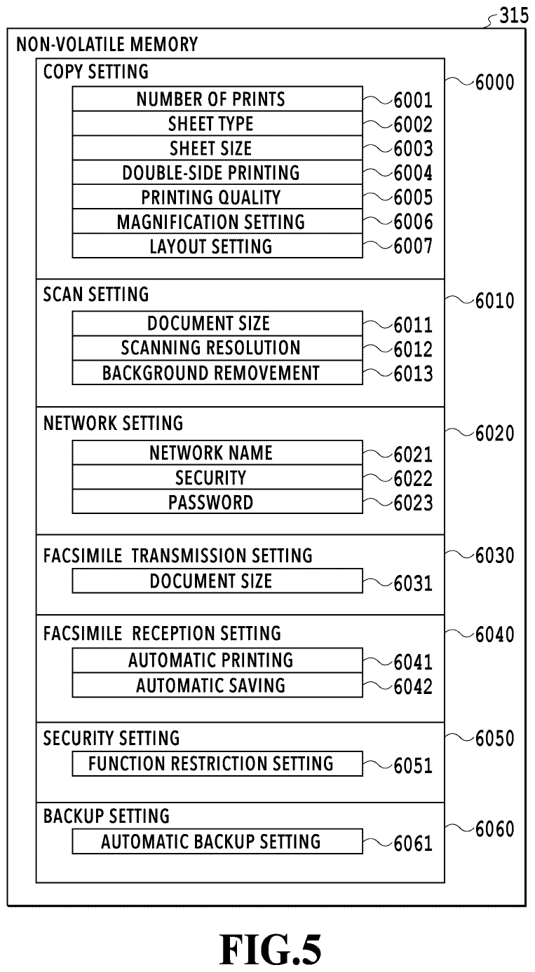

FIG. 5 is a diagram illustrating a data structure saved in the non-volatile memory 315. The data saved in the non-volatile memory 315 is divided and saved in regions from copy setting 6000 to backup setting 6060. In addition, various data such as a control parameter and an apparatus state variable are also saved in the non-volatile memory 315; however, mainly, a part of the various data that is related to the present disclosure is selectively described herein.

The copy setting 6000 is a region to store a setting value related to a copy operation. The region includes number of prints 6001, sheet type 6002, sheet size 6003, double-side printing setting 6004, printing quality 6005, and the like in copying. Additionally, copy magnification 6006 in enlarged/contracted copying, layout setting 6007 such as the number of layout pages and the order of layout in layout copying, and the like are included. Scan setting 6010 is a region to store a setting value related to a scanning operation. The region includes document size 6011 to be scanned, scanning resolution 6012, background removement setting 6013, and the like. Network setting 6020 is a region to store a setting value required for network connection. The region includes network name 6021 of an access point to be connected, security setting 6022 during connection, password 6023 to connect the access point, and the like. Facsimile transmission setting 6030 is a region to store a setting value required for facsimile transmission. For example, document reading size setting 6031 in a case of facsimile transmission and the like are included. Facsimile reception setting 6040 is a region to store a setting value required for an operation in a case of receiving the facsimile. The region includes automatic printing setting 6041 to determine whether to perform printing automatically in a case of facsimile reception and automatic saving setting 6042 to determine whether to perform saving into the USB memory 370 automatically in a case of facsimile reception. Security setting 6050 is a region to store a setting value required for security management of the printing apparatus 300. The region includes function restriction setting 6051 indicating whether to restrict the utilization function for the USB memory 370 (whether the function is executable) and the like. The backup setting 6060 is a region to store a setting value required for backup management of the printing apparatus 300. The region includes automatic backup setting 6061 indicating whether to perform automatic backup and the like.

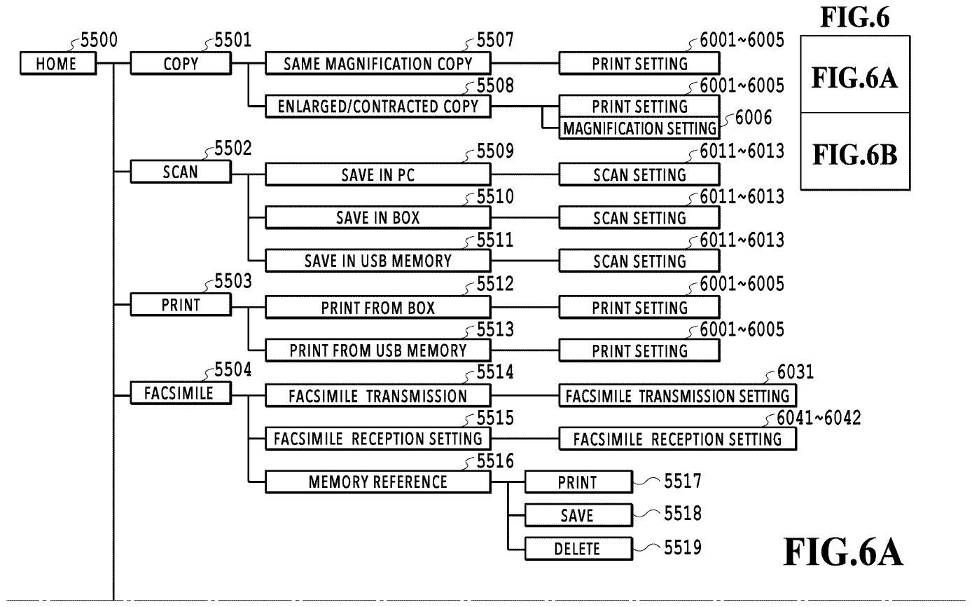

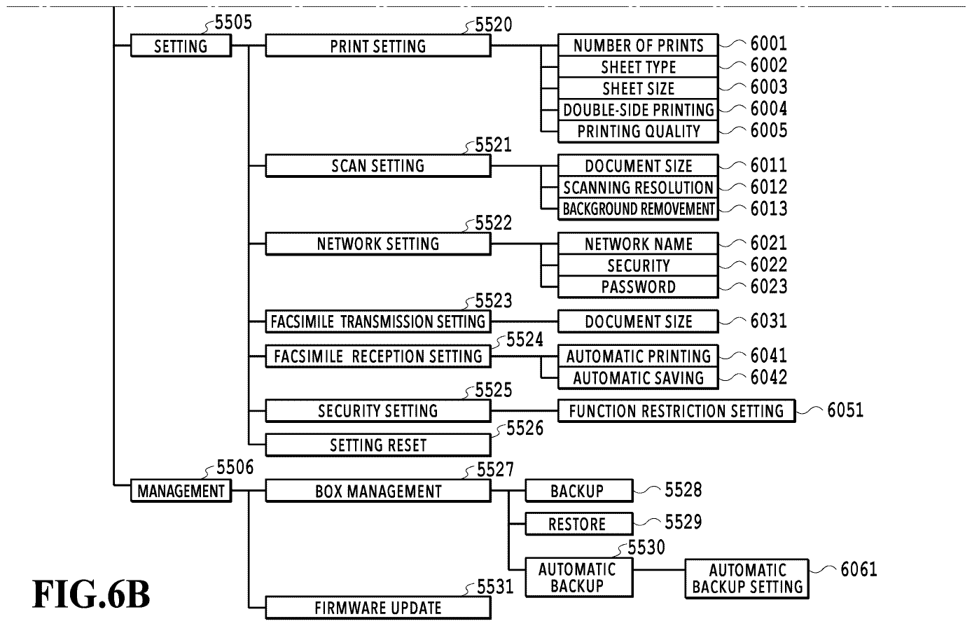

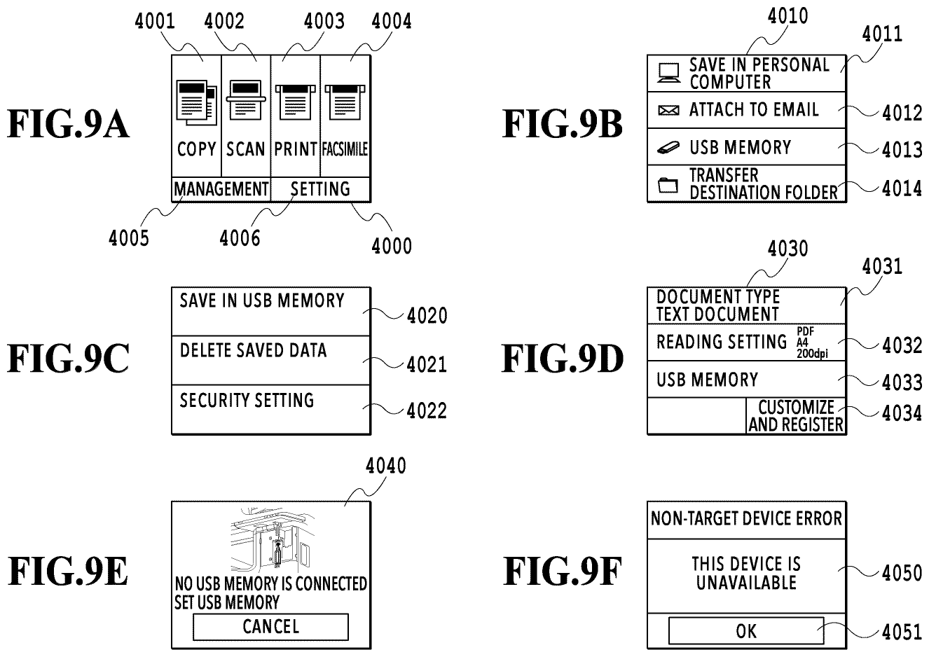

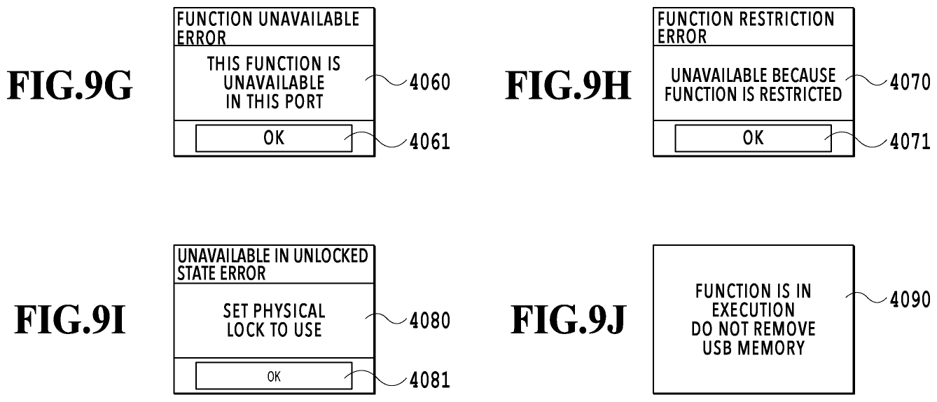

FIGS. 6A and 6B are a diagram illustrating a menu configuration and a setting item of the operation panel 303 in the printing apparatus 300. The menu configuration is illustrated as a tree structure including items set by a later-described home screen 4000 as a starting point, a screen that transitions by pressing a selection button, and a terminal screen. For example, a later-described home screen 4000 in FIG. 9A is comparable to a home 5500 of the menu configuration, and buttons comparable to menu items of copy 5501, scan 5502, print 5503, and facsimile 5504 are arranged. Additionally, function buttons 4005 and 4006 on the lower left and the lower right portions of the screen in FIG. 9A are comparable to the menu items, management 5506 and setting 5505, respectively.

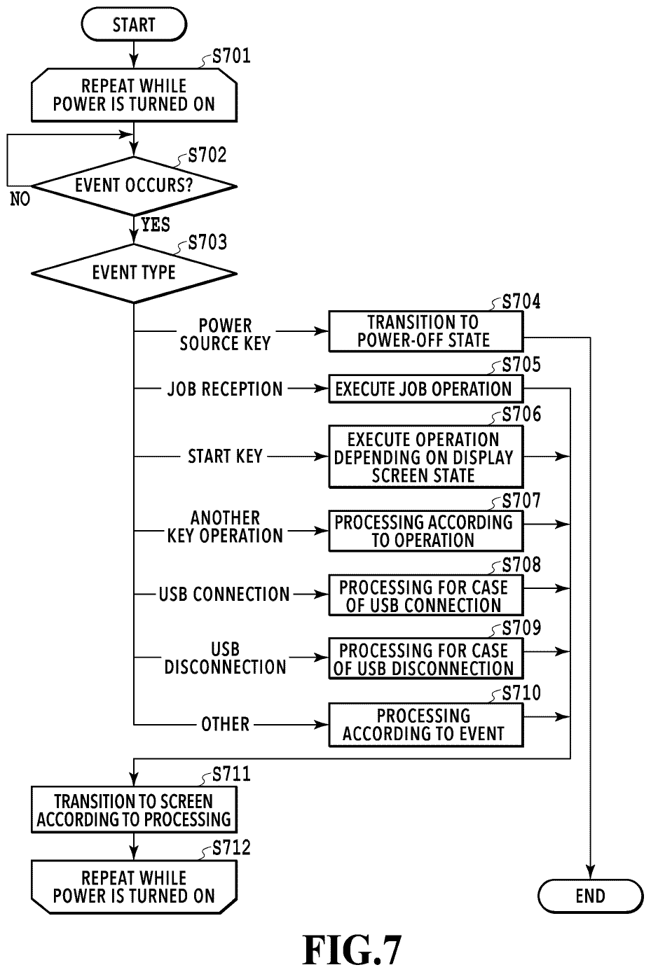

FIG. 7 is a flowchart illustrating processing by the CPU 311 in the printing apparatus 300. A series of processing illustrated in FIG. 7 is performed with the CPU 311 of the printing apparatus 300 deploying a program code stored in the program memory 313 to the data memory 314 to execute. Alternatively, a part of or all the functions of steps in FIG. 7 may be implemented by hardware such as an ASIC or an electronic circuit. Note that, a symbol “S” in the description of each processing means that it is a step in the flowchart.

The processing in FIG. 7 is executed by the CPU 311 of the printing apparatus 300 once the printing apparatus 300 is powered on, and while the printing apparatus 300 is powered on, the processing from S701 to S712 is repeatedly executed.

At the beginning of the repeated loop, in S702, the CPU 311 of the printing apparatus 300 determines whether an event occurs. In S702, the processing is repeated until the event occurs. If occurrence of the event is detected in S702, the processing proceeds to S703 and branches to necessary processing depending on a type of the event occurred. In S703, if the event is pressing of a power source key provided to the operation panel 303, the processing proceeds to S704, and the power-on state transitions to a power-off state. Accordingly, the processing exits the repeated loop, and the processing ends.

In S703, if the event is reception of a job execution instruction such as a printing job and a reading job from an external apparatus, the processing proceeds to S705, and an operation is executed according to the contents of the received job. In S703, if the event is pressing of a start key provided to the operation panel 303, the processing proceeds to S706, and an operation depending on a display screen state is executed. In S703, if the event is an operation performed on the operation panel 303, the processing proceeds to S707, and processing according to the performed operation is executed. For example, in a case of an operation on the touch panel, proper processing according to touched coordinates is performed. In a case where touching to the button arranged on the screen is detected, the screen transitions to a proper screen, or a proper operation is executed according to the pressed button.

In S703, if the event is detection of connection of the USB device to the USB port, the processing proceeds to S708, and processing for a case of USB connection is executed. For example, a type of the connected USB device is inspected, or the function of utilizing the USB device is validated depending on the type of the connected USB device and the like. In S703, if the event is detection of disconnection of the USB device from the USB port, the processing proceeds to S709, and processing for a case where the USB connection is disconnected is executed. For example, the function of utilizing the disconnected USB device is invalidated, or in a case where there is an operating function utilizing the USB device, intermission processing is performed. In S703, if the event is another event, in S710, processing according to the event is executed.

Once the processing according to the occurred event ends by the processing from S703 to S710, the processing proceeds to S711, and for the subsequent event processing, the processing from S701 to S712 is repeated while the power is turned on.

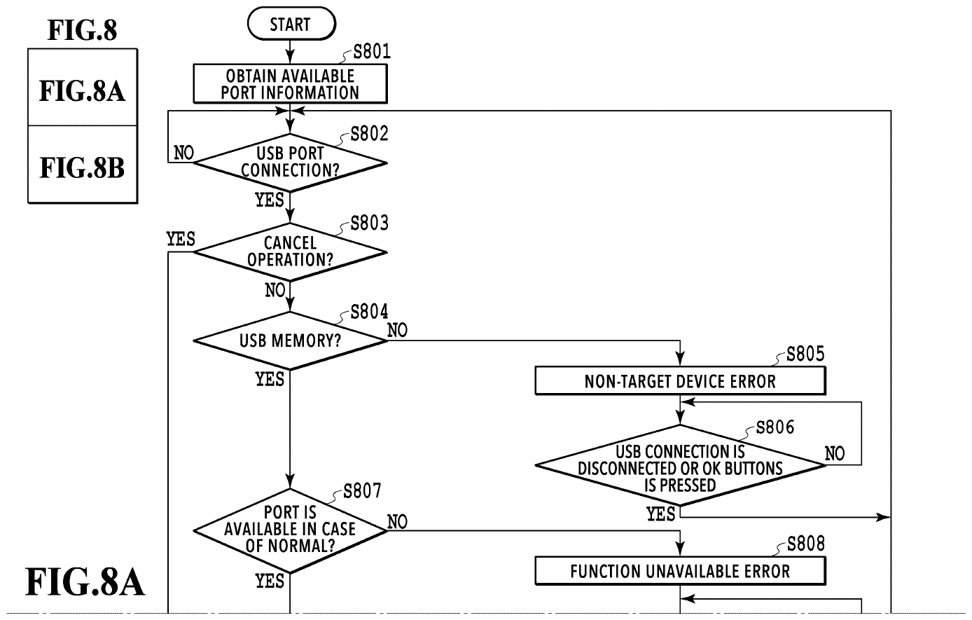

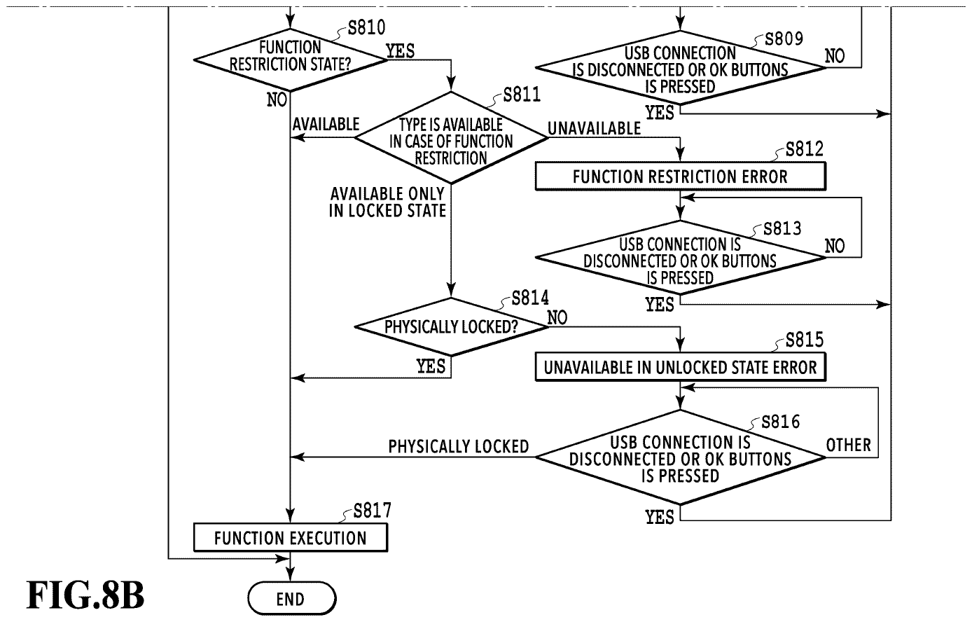

FIGS. 8A and 8B are a flowchart illustrating processing in a case where the USB device is connected to the USB ports 350 and 360 of the printing apparatus 300. FIGS. 9A to 9J are diagrams illustrating examples of a screen displayed on the operation panel 303 of the printing apparatus 300 (see FIG. 3). The processing illustrated in FIGS. 8A and 8B is included in the processing in S708 in FIG. 7. A series of processing illustrated in FIGS. 8A and 8B is performed with the CPU 311 of the printing apparatus 300 deploying a program code stored in the program memory 313 to the data memory 314 to execute. Alternatively, a part of or all the functions of steps in FIGS. 8A and 8B may be implemented by hardware such as an ASIC or an electronic circuit. Note that, a symbol “S” in the description of each processing means that it is a step in the flowchart.

The processing in FIGS. 8A and 8B is executed by the CPU 311 in a case of executing the function using the USB memory 370 (see FIG. 4) by operating the operation panel 303 (see FIG. 3) and in a case where the automatically executed function using the USB memory 370 (see FIG. 4) is validated.

Once the processing is started, in S801, the CPU 311 obtains available port information corresponding to the function to be executed from the function list illustrated in FIG. 4 (information obtainment). In the subsequent S802, the CPU 311 displays a USB device connection waiting screen 4040 (see FIG. 9E) and determines whether the USB device is connected to the USB port. In S802, the processing is repeated until the USB device is connected. In S802, if the USB device is connected (Yes), in S803, the CPU 311 determines whether a cancel operation is performed on the operation panel 303. If the cancel operation is performed (Yes), the processing of the present flowchart ends without performing the function execution. If the cancel operation is not performed (No), the CPU 311 allows the processing to proceed to S804 and determines whether the connected device is the USB memory 370 (memory determination).

In S804, if the connected device is not the USB memory 370 (No), the CPU 311 allows the processing to proceed to S805 and displays a non-target device error screen 4050 (see FIG. 9F). Note that, although only an error is notified in S805 in the present embodiment, in a case where the connected USB device should be connected to another port based on USB descriptor information, the position of the port in the apparatus to which the USB device should be connected may be indicated on the operation panel 303. For example, in a case where USB Wi-Fi is connected, and the apparatus has a place where the USB Wi-Fi can be functioned, a notification indicating that the USB Wi-Fi is available at the place and the position of the place may be displayed. Then, in S806, the CPU 311 determines whether the USB connection is disconnected, or an OK button 4051 is pressed on the non-target device error screen 4050 (see FIG. 9F). In S806, the processing is repeated until the USB device connection is disconnected, or the OK button 4051 is pressed. If the USB device is connected again, or the OK button 4051 is pressed, the processing is performed again from S802.

On the other hand, in S804, if the connected device is the USB memory 370 (Yes), the CPU 311 allows the processing to proceed to S807 and determines whether the port connected to the USB memory 370 is the port available in “normal” (port determination). If it is not the port available in “normal” (No), the processing proceeds to S808, and a function unavailable error screen 4060 (see FIG. 9G) is displayed. Then, in S809, the CPU 311 determines whether the USB connection is disconnected, or an OK button 4061 is pressed on the function unavailable error screen 4060. In S809, the processing is repeated until the USB connection is disconnected, or the OK button 4061 is pressed. If the USB memory 370 is connected to the correct port, or the OK button 4061 is pressed on the function unavailable error screen 4060, the processing is performed again from S802.

On the other hand, in S807, if the port connected to the USB memory 370 is the port available in “normal” (Yes), the processing proceeds to S810, and whether the security setting is “function restriction” is determined (restriction state determination). If it is not “function restriction” (No), the processing proceeds to S817, and a desired function is executed. On the other hand, in S810, if the security setting is “function restriction” (Yes), the CPU 311 allows the processing to proceed to S811 and determines whether the port is available in a case of function restriction (port availability determination). In S811, if a port availability type is “∘”, which means available, the processing proceeds to S817, and a desired function is executed. In S811, if the port availability type is “x”, which means unavailable, the processing proceeds to S812, and a function restriction error screen 4070 (see FIG. 9H) is displayed. Then, in S813, the CPU 311 determines whether the USB memory 370 is connected to the correct port, or an OK button 4071 is pressed on the function restriction error screen 4070. In S813, the processing is repeated until the USB connection is disconnected, or the OK button 4071 is pressed. If the USB memory 370 is connected to the correct port, or the OK button 4071 is pressed on the function restriction error screen 4070, the processing is performed again from S802.

In the present embodiment, the error screen 4070 is displayed in S812; however, for example, in a case where the USB device is connected to the USB port 350 that is the external port, but the USB device can be used by connecting to the USB port 360 that is the internal port, a notification prompting connection to the USB port 360 may be displayed. Once either processing is performed in S812, the processing is performed again from S802.

In S811, if the port availability type is available only in the locked state, the CPU 311 allows the processing to proceed to S814 and determines whether the USB memory 370 is physically locked (lock determination). If the USB memory 370 is physically locked (Yes), the processing proceeds to S817, and a desired function is executed. In S814, if the USB memory 370 is not physically locked (No), the processing proceeds to S815, and an unavailable in unlocked state error screen 4080 (see FIG. 9I) is displayed. Then, in S816, the CPU 311 determines whether the USB connection is disconnected, an OK button 4081 is pressed on the unavailable in unlocked state error screen 4080, or the USB memory 370 is physically locked. In S816, the processing is repeated until the USB connection is disconnected, the OK button 4081 is pressed, or the USB memory 370 is physically locked. If the USB connection is disconnected, or the OK button 4081 is pressed on the unavailable in unlocked state error screen 4080 (Yes), the processing is performed again from S803. In S816, if the USB memory 370 is physically locked, the processing proceeds to S817, and a desired function is executed.

Note that, in a configuration in which the physically locked state is electrically detectable, the CPU 311 can determine whether the USB memory 370 is physically locked by electrically reading the physically locked state. In a case of another configuration, it is also possible to perform the determination by setting and storing the physically locked state in a case of being physically locked and unlocked.

In S817, the CPU 311 executes a desired function. During the execution, a function-in-execution screen 4090 (see FIG. 9J) is displayed. Note that, displayed contents and a period of time of the displaying may be different between a case of executing the function using the USB memory 370 and a case of validating the automatically executed function using the USB memory 370. For example, in a case of executing the function using the USB memory 370, the function-in-execution screen 4090 is displayed until the execution is completed. Additionally, in a case of validating the automatically executed function using the USB memory 370, the function-in-execution screen 4090 is displayed for a certain period of time. Alternatively, an OK button may be provided to the function-in-execution screen 4090, and displaying of the function-in-execution screen 4090 ends once the OK button is pressed.

In FIG. 9A, the home screen 4000 is a screen displayed as a home screen on the operation panel 303 of the printing apparatus 300. One of buttons 4001 to 4006 displayed on the home screen 4000 and indicating the corresponding processing of the printing apparatus 300 is selected, and the screen transitions to an execution screen of each processing of the printing apparatus 300. In a case where the button 4001 is selected, the screen transitions to a copy processing execution screen. In a case where the button 4002 is selected, the screen transitions to a scan processing execution screen 4030. In a case where the button 4003 is selected, the screen transitions to a print processing execution screen. In a case where the button 4004 is selected, the screen transitions to a facsimile processing execution screen. In a case where the button 4005 is selected, the screen transitions to a state management screen of the printing apparatus 300. In a case where the button 4006 is selected, the screen transitions to a main body setting screen of the printing apparatus 300.

It is possible to change various settings of the scan processing from each button displayed on the scan processing execution screen 4030. In a case where a button 4031 is selected, it is possible to change a document type of a scanning target. In a case where a button 4032 is selected, it is possible to change reading setting in a case of executing scanning. In a case where a button 4033 is selected, the screen transitions to a saving destination setting screen 4010 in FIG. 9B, and it is possible to change a saving destination of the scanned document. In a case where a button 4034 is selected, it is possible to customize and register various settings.

The saving destination of the scanned image is set from each option button displayed on the saving destination setting screen 4010. In a case where a button 4011 is selected, the saving destination of the scanned image is set to a personal computer connected to the printing apparatus 300. In a case where a button 4012 is selected, the scanned image is e-mailed to a designated address. In a case where a button 4013 is selected, the screen transitions to a USB memory operation screen illustrated in FIG. 9C. In a case where a button 4014 is selected, a transfer destination folder as the saving destination of the scanned image is set.

In FIG. 9C, in a case where a button 4020 is selected, the data is saved in the USB memory. In a case where a button 4021 is selected, the data saved in the USB memory is deleted. In a case where a button 4022 is selected, the security setting of the USB memory is performed.

The processing illustrated in FIGS. 8A and 8B is executed by starting the scan processing in a state in which the saving destination of the scanned image is set to the USB memory on the scan processing execution screen 4030 (see FIG. 9D).

Note that, a configuration including the USB port 350 that is the external port and the USB port 360 that is the internal port is described in the present embodiment; however, it is not limited thereto, and a configuration including multiple external ports and multiple internal ports may be applied.

Additionally, although an example in which a warning screen is displayed on the operation panel 303 is described in the present embodiment, it is not limited thereto, and any configuration is applicable as long as it has a notification function to notify the user of a predetermined state that needs a warning.

Thus, the USB port 350 and the USB port 360 are functioned by connecting to the USB memory 370, and the functions of the USB port 350 and the USB port 360 in a case of connecting to the USB memory 370 are set to be different from each other. In addition, in a case where the function of either one of the USB port 350 and the USB port 360 does not correspond to the connected USB memory 370, the warning screen is displayed on the operation panel 303 (warning display). Thus, it is possible to provide a technique of making it possible to connect a single type of the USB device to the multiple USB connection ports and using different functions depending on the multiple USB connection ports.

### Second Embodiment

In the following, a second embodiment of the present disclosure is described with reference to the drawings. Note that, a basic configuration of the present embodiment is similar to that of the first embodiment; for this reason, in the following, a characteristic configuration is described. In the present embodiment, processing of performing displaying depending on the executed function and the state of the USB connection port after the processing illustrated in FIGS. 8A and 8B of the first embodiment is described.

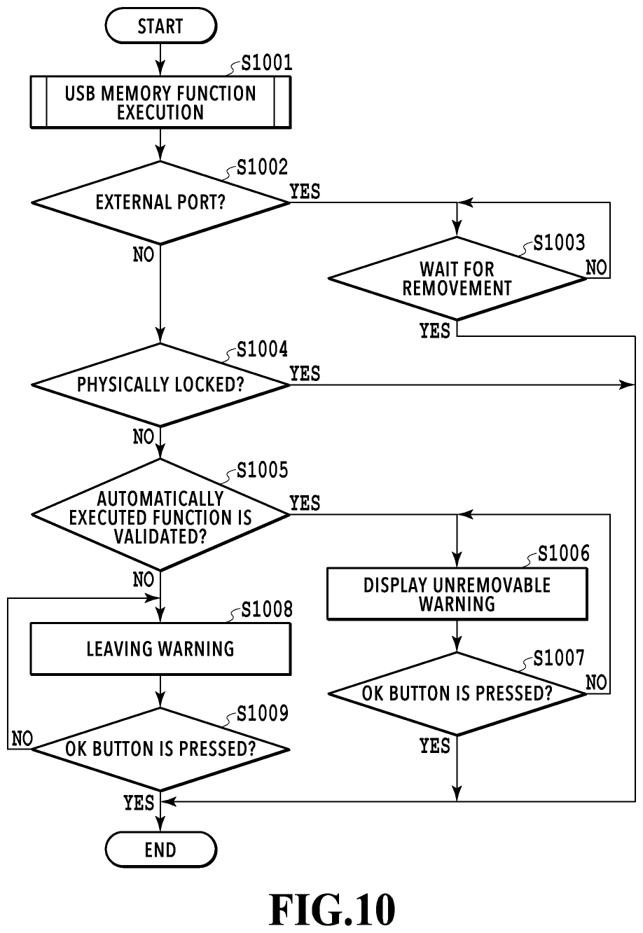

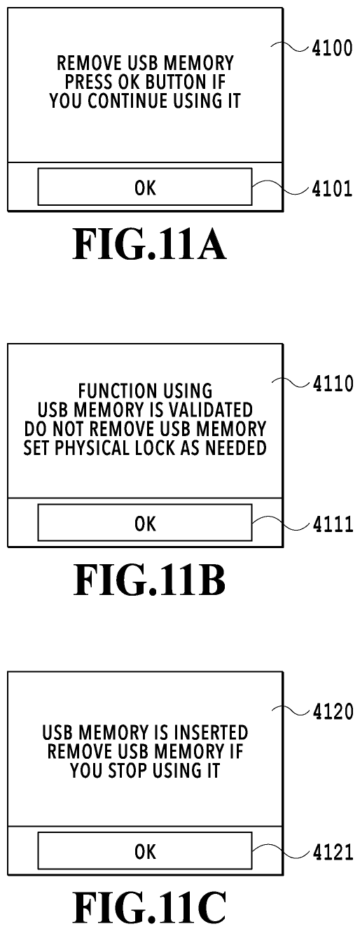

FIG. 10 is a flowchart illustrating processing in a case where the USB device is connected to the USB ports 350 and 360 in the present embodiment, and FIG. 11 is a diagram illustrating each screen displayed by processing in a case where the USB device is connected to the USB ports 350 and 360. A series of processing illustrated in FIG. 10 is performed with the CPU 311 of the printing apparatus 300 deploying a program code stored in the program memory 313 to the data memory 314 to execute. Alternatively, a part of or all the functions of steps in FIG. 10 may be implemented by hardware such as an ASIC or an electronic circuit. Note that, a symbol “S” in the description of each processing means that it is a step in the flowchart.

Once the processing is started, in S1001, the CPU 311 performs the processing described in FIGS. 8A and 8B in the first embodiment. Thereafter, in S1002, the CPU 311 determines whether the USB memory 370 to be used is connected to the USB port 350 that is the external port. If the USB memory 370 is connected to the USB port 350 (Yes), after the function is executed, there is a possibility that the user leaves the USB memory 370, and the USB memory 370 is lost or the information leaks. Therefore, the processing proceeds to S1003 to display a removement waiting screen 4100, and whether removing the USB memory 370 or pressing an OK button is executed is determined. The action accepted in this process is either removing the USB memory 370 from the port or pressing the OK button to execute the function using the same USB memory 370 again. In S1003, the processing is repeated until the USB memory 370 is removed from the port or the OK button is pressed. If the USB memory 370 is removed from the port, or the OK button is pressed (Yes), the present processing ends.

In S1002, if the port is not the external USB port 350 (No), the CPU 311 allows the processing to proceed to S1004 and determines whether the USB memory 370 is physically locked. If the USB memory 370 is physically locked (Yes), the present processing ends because it is unnecessary to warn the user about leaving the USB memory 370. If the USB memory 370 is not physically locked (No), the processing proceeds to S1005, and whether the automatically executed function is valid is determined. If the automatically executed function is valid (Yes), it is necessary to keep the USB memory 370 used for the automatically executed function being inserted; for this reason, the CPU 311 allows the processing to proceed to S1006 and displays an unremovable warning screen 4110 based on a determination result in S1005. Thereafter, the processing proceeds to S1007, and whether an OK button is pressed is determined. In S1007, the warning screen 4110 is displayed until the OK button is pressed. Once the OK button is pressed, the present processing ends. Note that, a message suggesting to physically lock the USB memory 370 to prevent loss and theft may be displayed on the unremovable warning screen 4110.

In S1005, if the automatically executed function is invalid (No), there is a possibility that the USB port 360 is temporarily used even though it is the internal USB port 360; for this reason, the processing proceeds to S1008 after the function execution, and a leaving warning screen 4120 is displayed. Thereafter, the processing proceeds to S1009, and whether an OK button is pressed is determined. In S1009, the warning screen 4120 is displayed until the OK button is pressed. Once the OK button is pressed, the present processing ends.

Note that, since it is difficult to visually confirm whether the USB memory 370 is inserted in the internal USB port 360, it is considered that the internal USB port 360 has a higher risk of leaving the USB memory 370 in a case of temporal use than that of the external USB port 350. Accordingly, also in this case, as with the removement waiting screen 4100, control may be performed to wait for removing the USB memory 370 from the port.

The removement waiting screen 4100 (see FIG. 11A) is displayed in a case where the USB memory 370 to be used is connected to the external USB port 350 in a case of executing the function using the USB memory 370. In a case of either removing the USB memory 370 from the port or pressing an OK button 4101, the screen transitions to the screen of the function using the USB memory 370 as illustrated in the execution screen 4030 (see FIG. 9D), for example.

The unremovable warning screen 4110 (see FIG. 11B) is displayed in a case where the automatically executed function is validated in executing the function using the USB memory 370. With an OK button 4111 being pressed, the screen transitions to the execution screen 4030 of the function using the USB memory 370, for example.

Then, in a case where the execution of the function using the USB memory 370 ends, the screen transitions to the leaving warning screen 4120 (see FIG. 11C). In a case of either removing the USB memory 370 from the port or pressing an OK button 4121, the execution of the function using the USB memory 370 ends.

Thus, it is possible to perform proper control depending on the port in which the USB memory 370 is inserted and the executed function, such as warning about leaving the USB memory 370 and suggesting the physical lock. For example, in a case where the USB memory 370 is used in the internal USB port 360, there is a higher risk of leaving the USB memory 370 than a case of connecting to the external USB port 350; therefore, it is possible to display the leaving warning screen 4120 to prevent the risk. Additionally, in a case where a function to use the USB memory 370 by constantly connecting is set, it is possible to display the unremovable warning screen 4110 to display a message suggesting the physical lock.

### Third Embodiment

In the following, a third embodiment of the present disclosure is described with reference to the drawings. Note that, a basic configuration of the present embodiment is similar to that of the first embodiment; for this reason, in the following, a characteristic configuration is described. In the first embodiment, the processing illustrated in FIGS. 8A and 8B includes the processing of determining whether the USB memory is connected. In contrast, in the present embodiment, processing of determining whether a USB device having a memory function is connected is included.

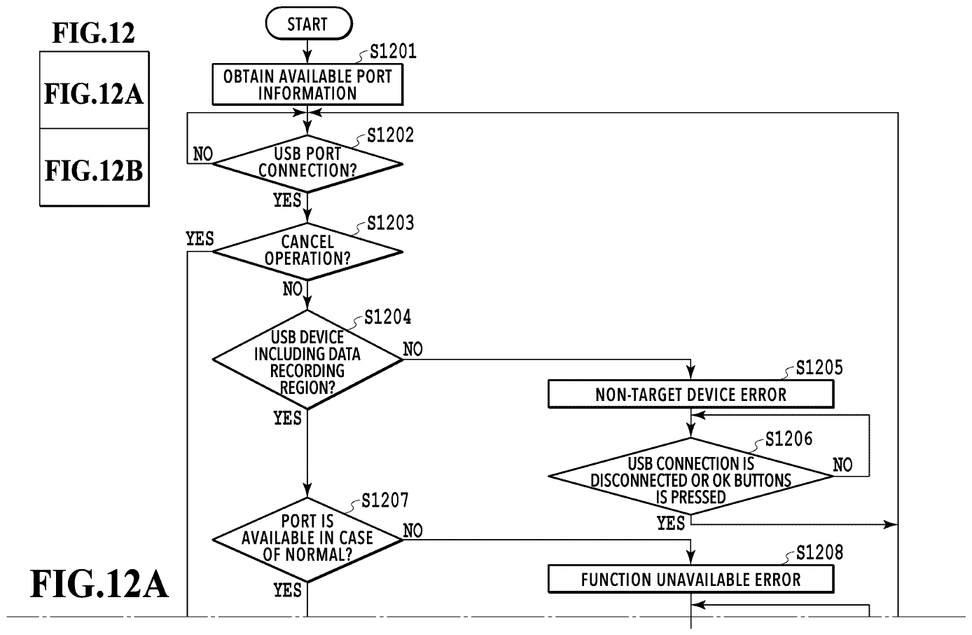

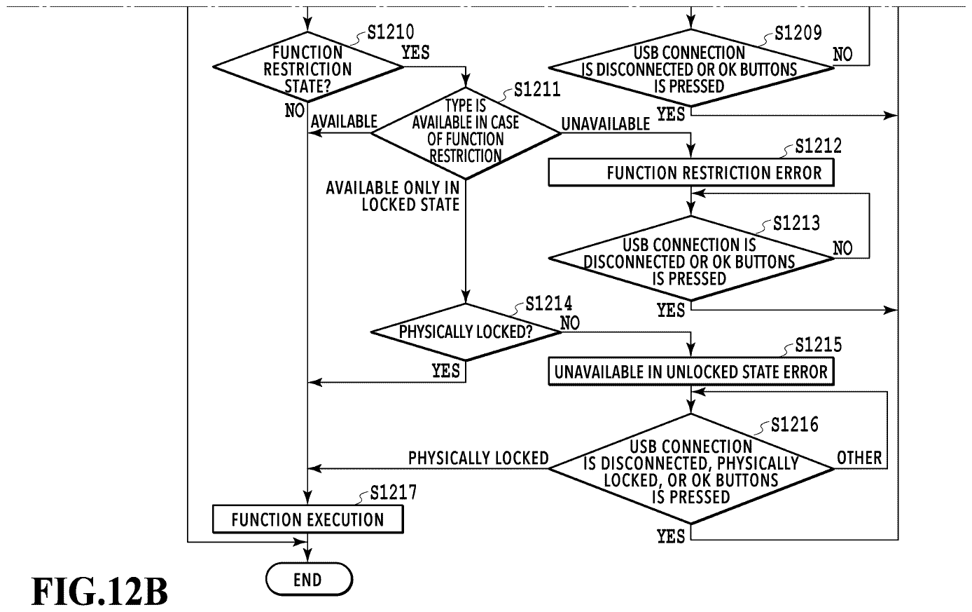

FIGS. 12A and 12B are a flowchart illustrating processing in a case where the USB device is connected to the USB ports 350 and 360 of the printing apparatus 300. The processing illustrated in FIGS. 12A and 12B is included in the processing in S708 in FIG. 7. A series of processing illustrated in FIGS. 12A and 12B is performed with the CPU 311 of the printing apparatus 300 deploying a program code stored in the program memory 313 to the data memory 314 to execute. Alternatively, a part of or all the functions of steps in FIGS. 12A and 12B may be implemented by hardware such as an ASIC or an electronic circuit. Note that, a symbol “S” in the description of each processing means that it is a step in the flowchart.

Other than the processing in S1204 in FIGS. 12A and 12B, the processing is similar to the processing from S801 to S803 and the processing from S805 to S817 illustrated in FIGS. 8A and 8B; for this reason, the description is omitted.

In S1204, whether the connected USB device is a USB device including a data storage region (having the memory function) is determined. In this case, the USB device including the data storage region is a digital camera or the like, for example. The digital camera or the like including the data storage region is connected to the USB port 350 or the USB port 360, and the processing of each function (see FIG. 4) is performed in the memory inside the device.

Thus, the functions of the USB port 350 and the USB port 360 in a case where the USB device including the data storage region is connected may be set to be different from each other.

### Other Embodiments

The present disclosure can also be implemented by processing of supplying a program implementing one or more functions of the above-described embodiments to a system or an apparatus via a network or a storage medium and reading out and executing the program by one or more processors of a computer in the system or the apparatus. Additionally, the present disclosure can also be implemented by a circuit (for example, an ASIC) implementing one or more functions.

According to the present disclosure, it is possible to provide a technique of making it possible to connect a single type of a USB device to multiple USB connection ports and using different functions depending on the multiple USB connection ports.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-211183, filed Dec. 4, 2024, which is hereby incorporated by reference herein in its entirety.

What is claimed is:

1. A printing apparatus, comprising:
a first USB port;
a second USB port different from the first USB port;
a notification unit configured to perform notification in a predetermined state; and
a control unit configured to perform control related to connection of a USB device including a data storage region to the first USB port and the second USB port and control of the notification unit, wherein
the first USB port and the second USB port can be functioned by connecting to the USB device,
functions of the first USB port and the second USB port in a case of connecting to the USB device can be set to be different from each other, and
in a case where the function of either one of the first USB port and the second USB port does not correspond to the connected USB device, the control unit performs notification by the notification unit.

2. The printing apparatus according to claim 1, wherein
the USB device is a USB memory.

3. The printing apparatus according to claim 2, wherein
the functions of the first USB port and the second USB port are set to be different from each other in a case of connecting to the USB memory according to security setting by an apparatus manager.

4. The printing apparatus according to claim 2, wherein
the notification unit is a display unit configured to display a warning screen.

5. The printing apparatus according to claim 2, wherein
the first USB port is provided to allow for connection from outside, and the second USB port is provided inside and allows for connection by opening a port cover.

6. The printing apparatus according to claim 5, wherein
the port cover is a part of an apparatus main body exterior cover.

7. The printing apparatus according to claim 5, wherein
the port cover includes a lock mechanism and can be physically locked in a closed state of the port cover.

8. The printing apparatus according to claim 7, wherein
a lock state of the lock mechanism is electrically detectable.

9. The printing apparatus according to claim 8, wherein
the control unit controls access of the USB memory connected to the second USB port based on authentication of an apparatus manager.

10. The printing apparatus according to claim 2, wherein
in a case where the function of the first USB port does not correspond to the USB memory connected thereto, the control unit displays a notification indicating that the USB memory is available by connecting to the second USB port.

11. The printing apparatus according to claim 2, wherein
at least one of a function to save scanned data, a function to output printing data, and a function to update firmware can be executed by using the USB memory connected to the first USB port or the second USB port.

12. The printing apparatus according to claim 3, wherein
the control unit controls whether the function is executable based on the security setting.

13. The printing apparatus according to claim 5, wherein
the storage region of the USB device connected to the second USB port is used automatically as an expansion memory based on a usage status of a built-in memory in the printing apparatus.

14. The printing apparatus according to claim 5, wherein
a function to automatically save facsimile reception data in the USB memory connected to the second USB port is provided.

15. The printing apparatus according to claim 2, wherein
a message for a user is displayed depending on a function executed for the USB memory connected to the first USB port and the second USB port.

16. The printing apparatus according to claim 5, further comprising:
a plurality of the first USB ports; and
a plurality of the second USB ports.

17. A control method of a printing apparatus, comprising:
obtaining available port information corresponding to a function to be used;
determining whether a USB device including a storage region is connected to a port, which is determination;
determining whether the port connecting to the USB device is a port available in a state with no function restriction, which is port determination;
determining whether it is a function restriction state, which is restriction state determination;
determining whether the function is available in the function restriction state, which is port availability determination;
determining whether the USB device is physically locked, which is lock determination;
allowing a warning screen to be displayed according to at least one of determination results from the port determination, the restriction state determination, the port availability determination, and the lock determination; and
executing the function for the USB device, which is function execution.
